(19) United States
(12) Patent Application Publication
(10) Pub. No.: US 2026/0368308 A1
(43) Pub. Date: Nov. 19, 2026

(54) FILE ACCESS METHOD AND SYSTEM, ELECTRONIC DEVICE, AND MACHINE-READABLE STORAGE MEDIUM

(71) Applicant: CLOUD INTELLIGENCE ASSETS HOLDING (SINGAPORE) PRIVATE LIMITED, Singapore (SG)

(72) Inventors: Lingfeng XIANG, Arlington, TX (US); Qingda LU, Bellevue, WA (US); Jiesheng WU, Bellevue, WA (US); Lei WANG, Hangzhou, Zhejiang (CN)

(21) Appl. No.: 19/477,440

(22) PCT Filed: May 9, 2024
(86) PCT No.: PCT/CN2024/091976

§ 371 Date: Oct. 21, 2025

(30) Foreign Application Priority Data
May 11, 2023 (CN) 202310532937.2

(51) Int. Cl. G06F 21/53; G06F 12/14; G06F 21/62

(52) U.S. Cl. CPC G06F 21/53; G06F 12/145; G06F 21/6209

(57) ABSTRACT

One or more embodiments of the specification provide a file access method. The method is applied to a file system client corresponding to a secure container running in a guest; the file system client includes a proxy service program deployed in a host user space and a file access service program deployed in a guest kernel space; and the method includes: loading a shared memory space between the proxy service program and the file access service program for a target secure container; copying, by the proxy service program, file data in a file system proxied by the proxy service program to the shared memory space; and obtaining, by the file access service program corresponding to the target secure container, target file data from the shared memory space, in response to an access request of the target secure container for the target file data.

### CROSS-REFERENCE TO RELATED APPLICATIONS

This application is a National Stage of International Application No. PCT/CN2024/091976, and filed on May 9, 2024, which claims priority to Chinese Patent Application No. 202310532937.2, filed with the China National Intellectual Property Administration on May 11, 2023 and entitled “FILE ACCESS METHOD AND SYSTEM, ELECTRONIC DEVICE, AND MACHINE-READABLE STORAGE MEDIUM”. The disclosures of the aforementioned applications are hereby incorporated by reference in their entireties.

### TECHNICAL FIELD

One or more embodiments of this specification relate to the field of secure container technologies, and in particular, to a file access method and system, an electronic device, and a machine-readable storage medium.

### BACKGROUND

A cloud file service based on a distributed file system protocol may enable file data to be accessed and shared via a network, with relatively high flexibility.

When a secure container needs to access file data stored in a file, a file system client usually first needs to be deployed on a guest on which the secure container is located, and a private data cache needs to be reserved for the file system client. Further, the file system client may obtain, through various communication protocols and file system protocols, a file in a file system from a file system server, and write the obtained file into the private data cache reserved for the file system client. If a plurality of secure containers respectively deployed on a plurality of guests need to access a same file in the file system, a file system client usually needs to be deployed on a guest in which each secure container is located, respectively, and a private data cache is reserved for each file system client, respectively.

As can be seen, in the related technology, when a secure container accesses a file in a file system, there are problems of relatively large memory overheads and relatively large virtualization overheads.

### SUMMARY

The present disclosure provides a file access method, where the method is applied to a file system client corresponding to a secure container running in a guest; the file system client includes a proxy service program deployed in a host user space and a file access service program deployed in a guest kernel space; and the method includes: loading a shared memory space between the proxy service program and the file access service program for a target secure container; copying, by the proxy service program, file data in a file system proxied by the proxy service program to the shared memory space; and obtaining, by the file access service program corresponding to the target secure container, target file data from the shared memory space, in response to an access request of the target secure container for the target file data.

The present disclosure further provides a file access system, where the file access system includes a file system client corresponding to a secure container running in a guest; the file system client includes a proxy service program deployed in a host user space and a file access service program deployed in a guest kernel space; and the file system client is configured to implement the foregoing method.

The present disclosure further provides an electronic device, including a communication interface, a processor, a memory, and a bus, where the communication interface, the processor, and the memory are connected to each other through the bus; and the memory stores a machine-readable instruction, and the processor performs the foregoing method by calling the machine-readable instruction.

The present disclosure further provides a machine-readable storage medium, where the machine-readable storage medium stores a machine-readable instruction, and the machine-readable instruction, when called and executed by a processor, implements the foregoing method.

According to the foregoing embodiments, in an aspect, a shared memory space is provided for a proxy service program and a file access service program, and the shared memory space is loaded for a secure container, so that a file access service program corresponding to the secure container can directly obtain file data that needs to be accessed from the shared memory space without reserving a private data cache for each secure container, thereby reducing memory overheads and implementing high file I/O performance by using fewer memory resources in a virtualized environment.

In another aspect, since the proxy service program may copy file data in a file system to the shared memory space, and the file access service program may directly obtain the file data from the shared memory space, the file access service program directly interacts with a file system server without using a complex communication protocol, thereby reducing virtualization overheads in a file access process.

In still another aspect, in response to an access request of the target secure container for target file data, the file access service program corresponding to the target secure container may obtain the target file data from the shared memory space. Since the file access service program may access the file data by using a memory read/write instruction rather than using a system function such as file read/write, the efficiency of accessing the file data by the secure container is improved.

### BRIEF DESCRIPTION OF DRAWINGS

To describe technical solutions in embodiments of this specification more clearly, the following briefly describes the accompanying drawings required for describing the embodiments. Apparently, the accompanying drawings in the following description show merely some embodiments recorded in this specification, and a person of ordinary skill in the art may still derive other drawings from these accompanying drawings without creative efforts.

FIG. 1 is a schematic diagram of architecture of a file access system according to an exemplary embodiment.

FIG. 2 is a schematic diagram of architecture of another file access system according to an exemplary embodiment.

FIG. 3 is a flowchart of a file access method according to an exemplary embodiment.

FIG. 4 is a schematic diagram of a shared memory space according to an exemplary embodiment.

FIG. 5 is a schematic diagram of addressing an object based on a layout index according to an exemplary embodiment.

FIG. 6 is a schematic diagram of a copy-on-write mechanism according to an exemplary embodiment.

FIG. 7 is a schematic diagram of memory resource allocation according to an exemplary embodiment.

FIG. 8 is a schematic structural diagram of an electronic device in which a file access apparatus is located according to an exemplary embodiment.

FIG. 9 is a block diagram of a file access apparatus according to an exemplary embodiment.

### DESCRIPTION OF EMBODIMENTS

To make a person skilled in the art to better understand the technical solutions of this specification, the technical solutions in the embodiments of this specification are described clearly and completely below with reference to the accompanying drawings in the embodiments of this specification. Apparently, the described embodiments are merely some rather than all of the embodiments of this specification. Based on the embodiments of this specification, all other embodiments obtained by a person of ordinary skill in the art without creative efforts shall fall within the protection scope of this specification.

It should be noted that steps of a corresponding method are not necessarily performed according to a sequence shown and described in this specification in other embodiments. In some other embodiments, the methods may include more or fewer steps than those described in this specification. In addition, a single step described in this specification may be decomposed into a plurality of steps for description in other embodiments. A plurality of steps described in this specification may be combined into a single step for description in other embodiments.

With the arrival of a cloud native era, more and more users start to use containers. A container is a kernel virtualization technology of an operating system, and may be used for isolating a process.

A conventional container such as a runc container is based on an operating system virtualization technology, may use an operating system of a host, and share a host kernel with another process running in the host. By using a system resource management and control component (such as cgroups) and a Namespace mechanism, a system resource may be allocated to each process and each process may be isolated.

A secure container is based on a hardware virtualization technology, and may use an operating system of a lightweight virtual machine) mounted in the host. For example, the lightweight virtual machine may be specifically a micro virtual machine (microVM). Each virtual machine may have an independent guest kernel, and a secure container running in each virtual machine may use the kernel of the virtual machine without sharing a host kernel with another process running in the host. Therefore, compared with the conventional container, the secure container has better isolation and is more secure.

A cloud file service based on a distributed file system protocol may enable file data to be accessed and shared via a network, and has relatively high flexibility. Since storage and computing may be separated by using the cloud file service, the cloud file service may also be referred to as a storage service, which is not specifically limited in this specification. For example, the cloud file service may specifically include, but is not limited to, a file service based on an NFS (Network File System), an HDFS (Hadoop Distributed File System), or the like.

When a secure container needs to access file data stored in a file, a file system client usually first needs to be deployed in a guest in which the secure container is located, and a private data cache needs to be reserved for the file system client. Further, the file system client may obtain a file in a file system from a file system server by using various communication protocols and file system protocols, and write the obtained file into the private data cache reserved for the file system client.

If a plurality of secure containers respectively deployed in a plurality of guests need to access a same file in the file system, a file system client usually needs to be deployed on a guest in which each secure container is located, and a private data cache is reserved for each file system client. Further, each file system client may obtain a file in a file system from a file system server, and write the obtained file into the private data cache reserved for the file system client.

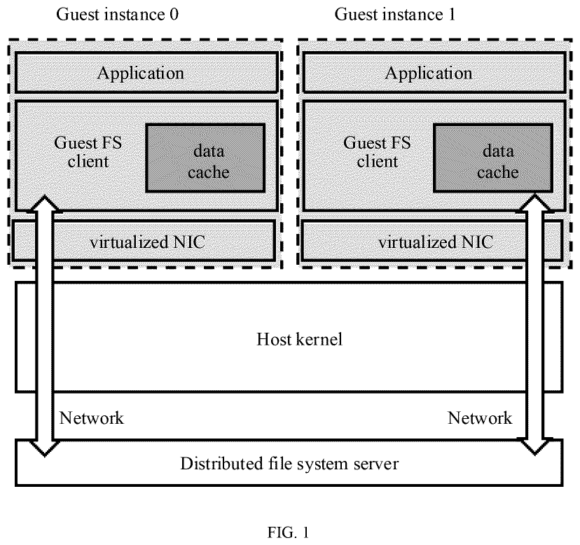

For example, referring to FIG. 1, FIG. 1 is a schematic diagram of architecture of a file access system according to an exemplary embodiment. As shown in FIG. 1, a secure container Guest Instance 0 and a secure container Guest Instance 1 may separately run on different guests on which a host is mounted, and may use guest kernels where the secure containers are located. To access a file in a file system, a file system client (Guest FS client) may be deployed for each of the secure container Guest Instance 0 and the secure container Guest Instance 1, and a private data cache may be reserved for each file system client. Further, each file system client may obtain a file in the file system from a distributed file system server via a network, and write the obtained file into a private data cache. Further, the file system client (Guest FS client) may provide the file data stored in the private data cache to an application running in a secure container. In addition, the secure container may further include a virtualized network interface card (virtualized NIC), configured to communicate with the distributed file system server, and details are not described herein again.

It can be seen that, in the embodiments of the related technology shown above, in an aspect, since a private data cache needs to be reserved for each file system client, memory overheads are relatively large. In addition, if a plurality of secure containers access a same file in the file system, a plurality of file copies of the file need to be respectively written into the private data caches reserved for the file system clients, which also causes a waste of memory resources.

In another aspect, although the secure container has better isolation and security than the conventional container, when accessing a file in the file system, the secure container still needs to use a more complex communication protocol, resulting in large virtualization overheads.

In view of this, this specification aims to provide a new file system client framework designed for a secure container, to achieve relatively high file data I/O performance by using relatively few memory resources in a virtualized environment.

The new file system client provided in this specification may include a proxy service program deployed in a host user space and a file access service program deployed in a guest kernel space, and a host on which a guest is mounted may provide a shared memory space for the proxy service program and the file access service program. Where the shared memory space may be considered as a virtual storage device. The proxy service program may serve as a proxy of a file system, and copy file data of one or more files in the file system to the shared memory space.

When the file system client is started or each secure container is started, the shared memory space may be loaded for each secure container that may need to access a file in the file system.

When a target secure container needs to access a file in the file system, in response to an access request of the target secure container for target file data, the file access service program corresponding to the target secure container may obtain the target file data from the shared memory space.

The target secure container may be any secure container that runs on any guest on which the host is mounted. The target file data refers to at least a part of file data stored in the file in the file system that the secure container needs to access. The file system may be a distributed remote file system, or may be a local file system of the host, which is not specifically limited in this specification.

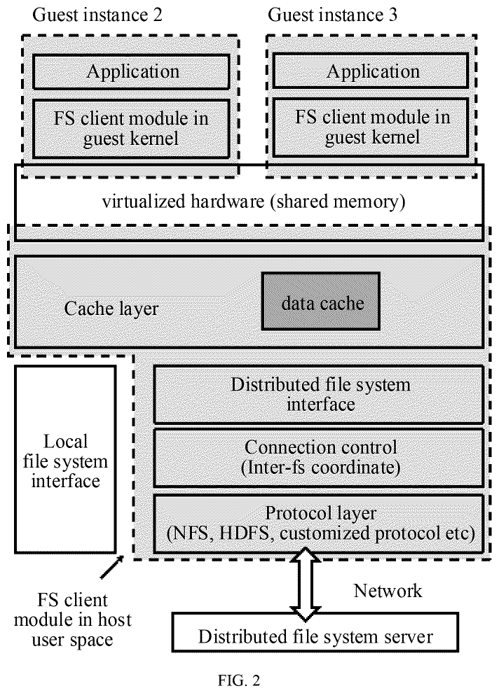

For example, referring to FIG. 2, FIG. 2 is a schematic diagram of architectural of another file access system according to an exemplary embodiment. As shown in FIG. 2, a secure container Guest Instance 2 and a secure container Guest Instance 3 may separately run on different guests on which a host is mounted, and may use guest kernels where the secure containers are located. A file system client corresponding to a secure container may include a proxy service program (FS client module in host user space shown in FIG. 2) and a file access service program that is deployed in a guest kernel space (FS client module in guest kernel shown in FIG. 2). Where a file access service program may be deployed for each secure container. File access service programs respectively corresponding to secure containers may communicate with the same proxy service program.

It should be noted that, as shown in FIG. 2, when a file system client is deployed for a secure container, a private data cache does not need to be reserved for each secure container, a shared memory space (shared memory) only needs to be provided for a proxy service program and a file access service program, and the shared memory space between the proxy service program and the file access service program is loaded for each secure container, so that the file access service programs respectively corresponding to the secure containers may access file data through the shared memory space.

As shown in FIG. 2, the proxy service program may serve as a proxy of a file system, access a file system server (distributed file system server) via a network, obtain file data in the file system from the file system server, and copy the obtained file data to the shared memory space. That is, for the host, the shared memory space may be considered as a memory mapping file, and the memory mapping file may be shared by a process running in a guest. Further, it is assumed that a target secure container is the secure container Guest Instance 2. In response to an access request of the secure container Guest Instance 2 for target file data, a file access service program corresponding to the secure container Guest Instance 2 (that is, the FS client module in guest kernel deployed in Guest Instance 2 in FIG. 2) may obtain the target file data from the shared memory space.

It can be seen that, in the technical solution in this specification, in an aspect, a shared memory space is provided for a proxy service program and a file access service program, and the shared memory space is loaded for a secure container, so that a file access service program corresponding to the secure container can directly obtain file data that needs to be accessed from the shared memory space without reserving a private data cache for each secure container, thereby reducing memory overheads and implementing high file I/O performance by using fewer memory resources in a virtualized environment.

In another aspect, since the proxy service program may copy file data in a file system to the shared memory space, and the file access service program may directly obtain the file data from the shared memory space, the file access service program directly interacts with a file system server without using a complex communication protocol, thereby reducing virtualization overheads in a file access process.

In still another aspect, in response to an access request of the target secure container for target file data, the file access service program corresponding to the target secure container may obtain the target file data from the shared memory space. Since the file access service program may access the file data by using a memory read/write instruction rather than by using a system function such as file read/write, the efficiency of accessing the file data by the secure container is improved.

The present disclosure is described below through specific embodiments and with reference to specific application scenarios.

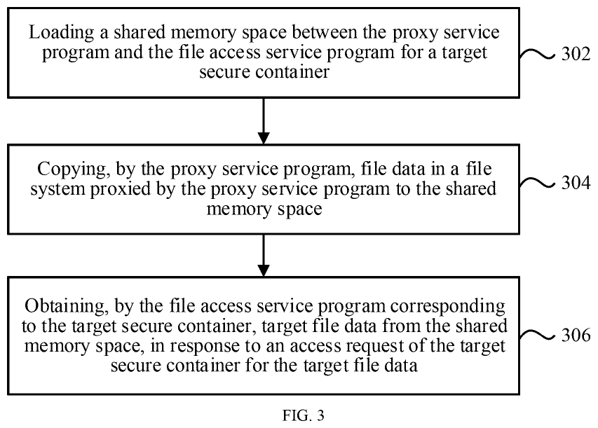

Refer to FIG. 3, FIG. 3 is a flowchart of a file access method according to an exemplary embodiment. The file access method may be applied to the file system client shown in FIG. 2. The file system client may include a proxy service program deployed in a host user space and a file access service program deployed in a guest kernel space.

The host may be specifically a bare-metal server, or may be another physical device. The guest may be specifically a lightweight virtual machine on which the host is mounted. The proxy service program may be specifically a thread or a process running in the host. The file access service program may be specifically a thread or a process running in the guest.

As shown in FIG. 3, the file access method may include the following steps.

Step 302, loading a shared memory space between the proxy service program and the file access service program for a target secure container.

For example, referring to FIG. 2, the secure container Guest Instance 2 and the secure container Guest Instance 3 may separately run on different guests on which a host is mounted. The host may provide a shared memory space (shared memory) between the proxy service program and the file access service program. In response to that the target secure container Guest Instance 2 is started, or in response to that the file system client is started, a shared memory space (shared memory) may be loaded for the target secure container Guest Instance 2.

In step 302, the shared memory space may also be referred to as a shared memory, a shared memory window, or the like, which is not specifically limited in this specification. The shared memory space is an addressable space that may be shared by the host and a plurality of virtual machines on which the host is mounted.

In an implementation that is shown, in response to that the file system client is started, a virtual address space corresponding to the shared memory space may be allocated to the proxy service program; and a shared physical address space corresponding to the shared memory space may be applied for to the proxy service program, and the shared physical address space that has been applied for may be mapped to the virtual address space allocated to the proxy service program, to load the shared memory space for the proxy service program.

In this case, in response to that the target secure container is started or the file system client is started, the loading the shared memory space between the proxy service program and the file access service program for the target secure container may specifically include: allocating a private virtual address space corresponding to the shared memory space to a file access program corresponding to the target secure container; and mapping a shared physical address space that is applied for by the proxy service program and that corresponds to the shared memory space to the private virtual address space allocated to the file access program corresponding to the target secure container, to complete loading of the shared memory space for the target secure container.

Step 304, copying, by the proxy service program, file data in a file system proxied by the proxy service program to the shared memory space.

For example, referring to FIG. 2, the proxy service program (that is, the FS client module in host user space in FIG. 2) may serve as a proxy of the file system, and access a file system server (distributed file system server) by using an RPC (Remote Procedure Call); and the proxy service program may obtain file data in the file system periodically according to a preset period or based on an actual requirement for file access, and copy the obtained file data to a shared memory space (shared memory).

For another example, the proxy service program may first access a file system server by using an RPC, store a file obtained from the file system server to a local file system, and then copy file data in the file stored in the local file system to a shared memory space (shared memory).

In step 304, the copying, by the proxy service program, the file data in the file system proxied by the proxy service program to the shared memory space may specifically include: writing, by the proxy service program, the file data in the file system proxied by the proxy service program into a shared physical address space corresponding to the shared memory space, mapping the file data written into the shared physical address space to a virtual address space allocated to the proxy service program, and mapping the file data written into the shared physical address space to a private virtual address space allocated to a file access service program corresponding to each secure container.

In addition, since a cache size of the shared memory space is limited, as shown in FIG. 2, the host may further deploy a cache layer for the file system client, the cache layer may include a data cache, and the data cache may be used for storing file data that is replaced from the shared memory space due to insufficient space. The cache layer may be further used for managing a file lease (lease), refreshing and abolishing file data cached locally, and the like. A buffer layer may be specifically stacked on a local file system of the host or a client of a remote file system, which is not specifically limited in this specification.

In addition, as shown in FIG. 2, a protocol layer may be further deployed in the host for the file system client, so that the file system client conforms to the NFS, the HDFS, or another file system protocol. A connection layer (Connection control) of user space pooling may be further deployed in the host for the file system client, to implement a high-performance flexible network.

In an implementation that is shown, the shared memory space is not only used for caching file data, but also used for caching index data corresponding to written file data.

During implementation, the copying, by the proxy service program, the file data in the file system proxied by the proxy service program to the shared memory space may specifically include: copying, by the proxy service program, the file data in the file system proxied by the proxy service program to a first memory address space in the shared memory space, where the first memory address space is used for storing file data shared by the file access service program and the proxy service program; and storing, by the proxy service program, a layout index corresponding to the file data copied to the first memory address space into the shared memory space, where the layout index is used for indicating an index node of the file data corresponding to the layout index, and is used for indicating a file offset of the file data corresponding to the layout index; and the file offset is an offset of the corresponding file data in a file in which the file data is located.

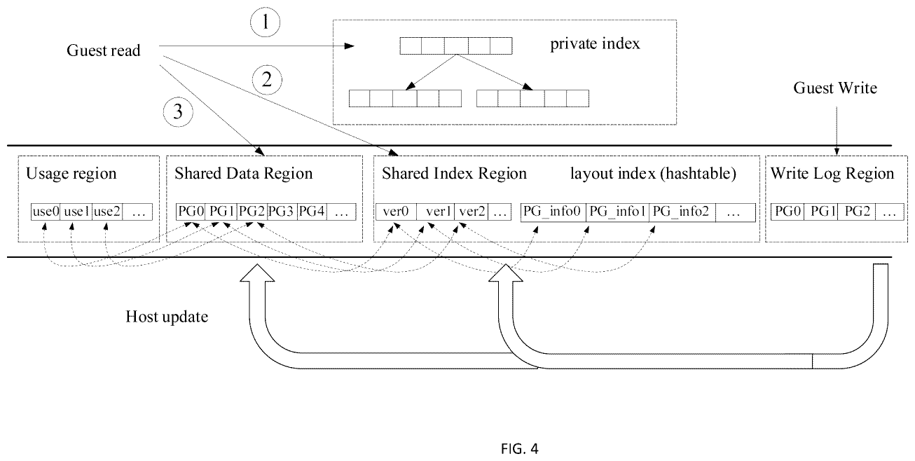

For example, referring to FIG. 4, FIG. 4 is a schematic diagram of a shared memory space according to an exemplary embodiment. As shown in FIG. 4, a proxy service program may copy file data in a file system to a shared data region in a shared memory space (shared memory); and the proxy service program may further store a layout index corresponding to the file data copied to the shared data region to a shared index region in the shared memory space (shared memory).

The file data stored into the shared data region may be managed by using a page cache mechanism of an operating system, that is, the file data may be written into a memory page (page) in the shared data region.

For example, as shown in FIG. 4, the proxy service program may copy the file data to a memory page PG0 in a page array in the shared data region, may store a layout index PG_info0 corresponding to the file data copied to the memory page PG0 into a PG_info array in the shared index region, and may further update a value of a version identifier ver0 in a version array in the shared index region. It should be noted that an array length of the PG_info array in the shared index region is the same as a quantity of memory pages in the shared data region, and is also the same as an array length of the version array in the shared index region, and slots are in a one-to-one correspondence. Where each slot in the PG_info array may include an inode identifier of a page corresponding to the slot and a file offset of file data in the page corresponding to the slot. That is, the PG_info array may be used as a fixed-size hashtable.

In some possible embodiments, since some memory management mechanisms provided by an operating system kernel need to be used to manage a shared memory page, a 64 B struct page usually needs to be reserved for each 4 KB page, to manage the corresponding page. However, in the technical solution of this specification, since the layout index corresponding to the file data in the shared data region does not participate in memory page management performed by the operating system, space occupied by metadata (that is, a struct page) does not need to be reserved for each memory page in the shared data region, thereby further saving memory resources.

Step 306, obtaining, by the file access service program corresponding to the target secure container, target file data from the shared memory space, in response to an access request of the target secure container for the target file data.

For example, after the shared memory space (shared memory) is loaded for the target secure container Guest Instance 2, and the proxy service program (FS client module in host user space) copies the target file data in the file system to the shared memory space, in response to an access request of the target secure container Guest Instance 2 for the target file data, the file access service program (FS client module in guest kernel) corresponding to the target secure container Guest Instance 2 may obtain the target file data from the shared memory space, and then may provide the obtained target file data to an application running in the target secure container Guest Instance 2.

It should be noted that in the embodiment shown above, the application running in the target secure container Guest Instance 2 may directly copy the target file data obtained by the file access service program (FS client module in guest kernel) from the shared memory space, and the file access service program (FS client module in guest kernel) does not need to cache the target file data obtained from the shared memory space.

In an implementation that is shown, since a cache size of the shared memory space is limited, and the file system can store massive file data, the proxy service program can copy only some of the file data in the file system to the shared memory space, and file data that the target secure container actually needs to access has unnecessarily been copied to the shared memory space.

In this case, the obtaining, by the file access service program corresponding to the target secure container, the target file data from the shared memory space, in response to the access request of the target secure container for the target file data may specifically include: searching for, by the file access service program corresponding to the target secure container, the target file data in the shared memory space, in response to the access request of the target secure container for the target file data; and reading, by the file access service program corresponding to the target secure container, the target file data from the shared memory space, if the file access service program corresponding to the target secure container finds the target file data in the shared memory space.

In step 306, the access request may be used for performing a read operation on the target file data.

For example, referring to FIG. 2, in response to an access request of the target secure container Guest Instance 2 for target file data, a file access service program corresponding to the target secure container Guest Instance 2 (that is, the FS client module in guest kernel deployed in Guest Instance 2 in FIG. 2) may search for the target file data in the shared memory space; and if the file access service program finds the target file data in the shared memory space, the file access service program may read the target file data from the shared memory space.

In this case, the obtaining, by the file access service program corresponding to the target secure container, the target file data from the shared memory space, in response to the access request of the target secure container for the target file data may specifically further include: sending, by the file access service program corresponding to the target secure container, an access request for the target file data to the proxy service program, if the file access service program corresponding to the target secure container does not find the target file data in the shared memory space; obtaining, by the proxy service program, the target file data from the file system, in response to the access request, and copying the obtained target file data to the shared memory space; and reading, by the file access service program corresponding to the target secure container, the target file data from the shared memory space.

For example, referring to FIG. 2, it is assumed that the target file data is specifically a page whose inode identifier is 10 and whose file offset is 8192; in response to an access request of the target secure container Guest Instance 2 for target file data, a file access service program corresponding to the target secure container Guest Instance 2 (that is, the FS client module in guest kernel deployed in Guest Instance 2 in FIG. 2) may search for the target file data in the shared memory space. If the file access service program does not find the target file data in the shared memory space, the file access service program corresponding to the target secure container Guest Instance 2 may send an access request RPC-0 for the target file data to the proxy service program (that is, the FS client module in host user space in FIG. 2). In response to the access request RPC-0, the proxy service program may send an access request RPC-1 for the target file data to a file system server (distributed file system server), obtain a target file in which the target file data is located from the file system server, and copy, according to a file offset, the target file data in the obtained target file to a shared data region included in the shared memory space, where an address offset of the target file data in the shared memory space may be 16384; and further, after receiving a response message of the access request RPC-0, the file access service program corresponding to the target secure container Guest Instance 2 may search for the target file data in the shared memory space again, and may read the target file data from a location at which the offset is 16384.

It should be noted that in the foregoing shown embodiment, since file data in the shared memory space may be shared by the host and secure containers running in a plurality of guests, and each secure container may manage a private virtual address space allocated to the secure container, after an address offset of the target file data in the shared memory space is determined, the file access service program corresponding to the target secure container may calculate, based on a base address of the target secure container and the address offset, a virtual address in a private virtual address space that is allocated to the secure container and to which the target file data is mapped.

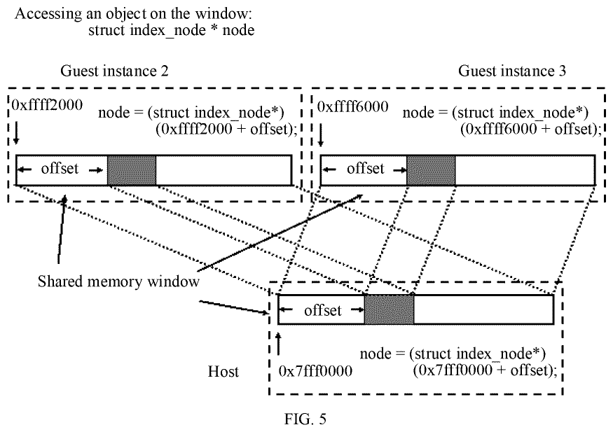

For example, referring to FIG. 5, FIG. 5 is a schematic diagram of addressing an object based on a layout index according to an exemplary embodiment. As shown in FIG. 5, base addresses of a secure container Guest Instance 2, a secure container Guest Instance 3, and a HOST are respectively 0xffff2000, 0xffff6000, and 0x7fff0000. In response to an access request of the target secure container Guest Instance 2 for the target file data, if an address offset of target file data found by a file access service program corresponding to the target secure container Guest Instance 2 in a shared memory space is “offset” (for example, 16384), the file access service program corresponding to the target secure container Guest Instance 2 may determine that a virtual address in a private virtual address space that is of the target secure container Guest Instance 2 and to which the target file data is mapped is (0xffff2000+offset).

In an implementation that is shown, the access request may carry a target layout index corresponding to the target file data. In this case, the obtaining, by the file access service program corresponding to the target secure container, the target file data from the shared memory space, in response to the access request of the target secure container for the target file data may specifically include: calculating, by the file access service program corresponding to the target secure container, a hash value of the target layout index, in response to the access request of the target secure container for the target file data, performing a modulo operation on the hash value, and determining a target memory address of the target file data in the first memory address space according to a modulo value; determining whether a layout index that corresponds to the target memory address and that is stored in the shared memory space is consistent with the target layout index; and reading, by the file access service program corresponding to the target secure container, the target file data from the first memory address space according to the target memory address, if the layout index corresponding to the target memory address is consistent with the target layout index.

For example, it is assumed that the target file data is specifically file data in a target page whose inode identifier is 10 and whose file offset is 8192; in response to the access request of the target secure container Guest Instance 2 for the target file data, the file access service program corresponding to the target secure container Guest Instance 2 can calculate a hash value of the target layout index, perform a modulo (mod) operation on the calculated hash value, determine, according to a modulo value, that the target page is a memory page PG100 in a page array, and determine that a layout index corresponding to the memory page PG100 is PG_info100 in a PG_info array; and further, if it is determined that the layout index PG_info100 includes the inode identifier of 10 and the file offset of 8192, which are consistent with those of the target layout index, the file access service program corresponding to the target secure container Guest Instance 2 can read the target file data in the memory page PG100 from a shared data region.

In an implementation that is shown, to ensure the security of the file data cached in the shared memory space and prevent a malicious container instance from tampering with the file data cached in the shared memory space, only the host may be allowed to modify the file data in the shared data region; and the secure container may modify a copy of the file data based on a write log mechanism, and the host merges content modified by secure containers for the copy of the file data into the file data in the shared data region. In this implementation, based on features of the write log mechanism, memory overheads caused by the modification operation on the file data may also be reduced.

In this case, as shown in FIG. 2, the shared memory space may further include a private write log region allocated to the secure container. In step 306, if the access request initiated by the target secure container is used for performing a write operation on the target file data, the method may further include: copying, by the file access service program corresponding to the target secure container, the found target file data to a second memory address space in the shared memory space, where the second memory address space is a memory address space that is allocated to the target secure container in the shared memory space and that is used for performing a write log operation on the target file data; performing, by the file access service program corresponding to the target secure container, a write log operation on the target file data copied to the second memory address space, to obtain target file data modified by the target secure container; and updating, by the proxy service program, the target file data stored in the first memory address space according to the target file data that is modified by the target secure container and that is stored in the second memory address space.

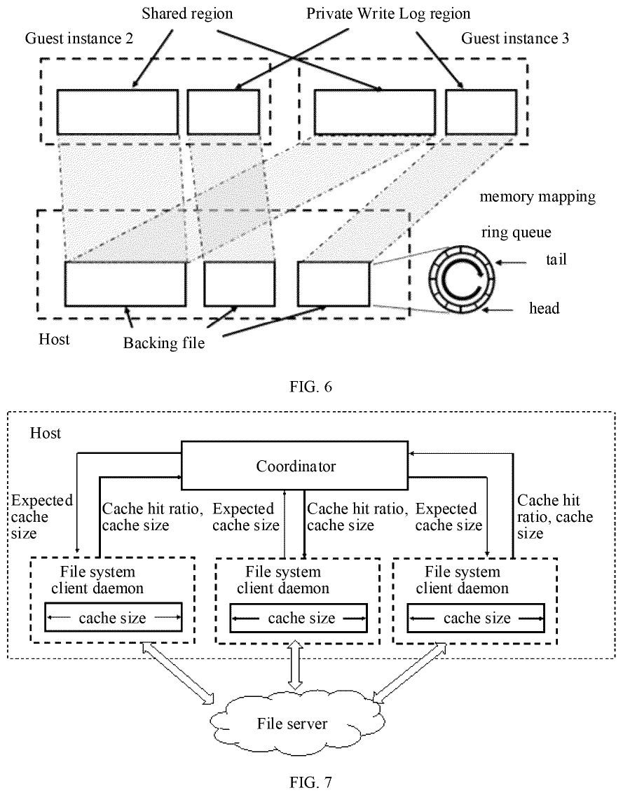

For example, referring to FIG. 6, FIG. 6 is a schematic diagram of a write log mechanism according to an exemplary embodiment. As shown in FIG. 6, file data cached in a shared data region of a shared memory space may be separately mapped to a private virtual address space of a secure container Guest Instance 2 and a private virtual address space of a secure container Guest Instance 3. If the target secure container Guest Instance 2 requests to perform a write operation on target file data cached in the shared data region, a private write log region may be first allocated to the target secure container Guest Instance 2 in the shared memory space, and the target file data cached in the shared data region is copied to the write log region, so that the target secure container Guest Instance 2 may perform a write operation on the target file data in its own private write log region, to obtain target file data modified by the target secure container Guest Instance 2. Further, a ring queue may be used for storing the file data modified by the target secure container Guest Instance 2 in the write log region. A proxy service program may check a state of the ring queue, and may update, according to the target file data modified by the target secure container Guest Instance 2, the target file data stored in the shared data region. That is, the proxy service program may merge, into the shared data region, content modified by the target secure container for the target file data. For a specific implementation of the write log mechanism, refer to the related technology. Details are not described herein again.

Specifically, the modifying the file data in the shared data region may include two cases: updating page content and replacing a page.

In some possible embodiments, in addition to storing file data and index data, the shared memory space may further store a use identifier and a version identifier that correspond to the file data. Where the use identifier may be used for indicating whether a write operation is being performed on the corresponding file data. The version identifier may be used for indicating the number of times that the corresponding file data is modified by the secure containers.

For example, as shown in FIG. 4, the shared memory space may further include a usage track region. The usage track region may be used for recording an access status of a secure container to file data cached in each memory page in the shared data region. If a secure container accesses file data cached in the memory page PG0, a value of the use identifier use0 corresponding to the memory page PG0 may be updated from 0 to 1. The shared index region of the shared memory space may further include a version identifier array (version array). The version identifier array may be used for recording version identifiers in a one-to-one correspondence with memory pages in the shared data region.

In this case, the method may further include: updating a use identifier corresponding to the target file data from a first value to a second value, in response to that the write log operation is performed on the target file data, where in case of being the first value, the use identifier is used for indicating that no write log operation is being performed on the corresponding file data; and in case of being the second value, the use identifier is used for indicating that a write log operation is being performed on the corresponding file data; and updating, in response to that the proxy service program completes updating the target file data stored in the first memory address space, the use identifier corresponding to the target file data from the second value to the first value, and updating a version identifier corresponding to the target file data.

For example, in response to that the file access service program corresponding to the target secure container Guest Instance 2 is performing a write log operation on the file data cached in the memory page PG0, a value of the use identifier use0 corresponding to the memory page PG0 may be updated from 0 to 1, to indicate that a write operation is being performed on the corresponding target file data; and in response to that the proxy service program completes updating the data cached in the memory page PG0 in the shared data region, the value of the use identifier use0 may be updated from 1 to 0, to indicate that the corresponding target file data is updated completely, and no write operation is being performed. In addition, the value of the version identifier ver0 corresponding to the memory page PG0 may be increased by 1.

In a possible example, the version identifier may be a 4-byte field, a highest bit in the field may be used as a tag bit PENDING, and the tag bit PENDING is used as a use identifier, thereby further saving memory resources.

In some other possible embodiments, if the access request is used for performing a read operation on the target file data, version identifiers corresponding to the target file data may be separately obtained before and after the read operation is performed on the target file data. If the version identifiers are consistent, it indicates that the target file data has not been modified during the read operation, and the latest version of the target file data is obtained; and if the version identifiers are inconsistent, it indicates that the target file data has been modified during the read operation, and a read operation needs to be performed on the target file data again, to obtain the latest version of the target file data.

In this case, the method may further include: obtaining the version identifier corresponding to the target file data from the shared memory space, in response to that the file access service program corresponding to the target secure container finds the target file data in the shared memory space; re-obtaining a version identifier corresponding to the target file data from the shared memory space, in response to that the file access service program corresponding to the target secure container completes reading the target file data from the shared memory space, and determining whether the re-obtained version identifier is consistent with the previously obtained version identifier; and re-reading, by the file access service program corresponding to the target secure container, the target file data from the shared memory space if the re-obtained version identifier is inconsistent with the previously obtained version identifier.

For example, in response to that the file access service program corresponding to the target secure container Guest Instance 2 finds the target file data in the shared memory space, a version identifier “n” corresponding to the target file data may be obtained from the shared memory space; in response to that the file access service program corresponding to the target secure container Guest Instance 2 completes reading the target file data from the shared memory space, a version identifier “n” corresponding to the target file data may be re-obtained from the shared memory space; and since the re-obtained version identifier is consistent with the previously obtained version identifier, it indicates that the file access service program corresponding to the target secure container Guest Instance 2 obtains the latest version of the target file data from the shared memory space.

For another example, in response to that the file access service program corresponding to the target secure container Guest Instance 2 finds the target file data in the shared memory space, the version identifier “n” corresponding to the target file data may be obtained from the shared memory space during the read operation, the secure container Guest Instance 3 performs a write operation on the target file data whose version identifier is “n”, so that the version identifier corresponding to the target file data is updated to “n+1”; in response to that the file access service program corresponding to the target secure container Guest Instance 2 completes reading the target file data from the shared memory space, a version identifier “n+1” corresponding to the target file data may be re-obtained from the shared memory space; and since the re-obtained version identifier is inconsistent with the previously obtained version identifier, it indicates that the version of the target file data obtained by the file access service program corresponding to the target secure container Guest Instance 2 from the shared memory space is not the latest version of the target file data. Therefore, the file access service program corresponding to the target secure container Guest Instance 2 needs to read the target file data from the shared memory space again, to obtain the latest version of the target file data.

In addition, in a possible example, to avoid a case that the target file data needs to be obtained from the shared memory space again, the file access service program may first determine, based on the use identifier corresponding to the target file data, whether a write operation is being performed on the target file data, and if yes, temporarily skip performing a read operation on the target file data.

For example, it is assumed that the secure container Guest Instance 3 is performing a write operation on the target file data, and a value of a tag bit PENDING corresponding to the target file data is updated from 0 to 1; and in response to that the file access service program corresponding to the target secure container Guest Instance 2 finds the target file data in the shared memory space, if the value 1 of the tag bit PENDING corresponding to the target file data may be obtained from the shared memory space, the file access service program corresponding to the target secure container Guest Instance 2 may temporarily not perform a read operation on the target file data until the value of the tag bit PENDING corresponding to the target file data is updated from 1 to 0.

It should be noted that in the foregoing embodiment, to avoid complex reasoning of a fault stop condition, the file system client may be designed as a lock-free model, and may implement atomic data read based on a version identifier and a fence instruction. When a CPU executes a plurality of machine instructions, an execution order of the machine instructions may be automatically adjusted. For example, in a process in which a target secure container performs a write operation on target file data, before updating target file data stored in the first memory address space, a proxy service program first updates a version identifier corresponding to the target file data. Consequently, a file access program corresponding to another secure container may mistakenly consider that the target file data has been updated completely. Therefore, based on the fence instruction, an execution order of “updating the use identifier corresponding to the target file data from the first value to the second value”→“performing the write operation on the target file data in the shared memory space”→“updating the use identifier corresponding to the target file data from the second value to the first value, and updating the version identifier corresponding to the target file data” can be ensured.

In an implementation that is shown, the file system client may support accessing a plurality of file systems; a plurality of proxy service programs that respectively proxy the plurality of file systems may be deployed in the host user space; and the shared memory space may include a plurality of shared memory subspaces respectively allocated to the plurality of proxy service programs.

In this case, the file system client needs to determine a cache size of a shared memory subspace allocated to each file system, and the method may further include: determining, according to a quantity of access times that the target secure container accesses each file system of the plurality of file systems, a cache size of a shared memory subspace allocated to each file system.

For example, referring to FIG. 7, FIG. 7 is a schematic diagram of memory resource allocation according to an exemplary embodiment. As shown in FIG. 7, a daemon of each file system client may determine a cache hit ratio corresponding to each file system and a cache size of a shared memory subspace currently allocated to each file system. Further, a coordinator running in the host may determine, according to a quantity of access times that the target secure container accesses each file system, a cache size (Expected cache size) of a shared memory subspace allocated to each file system.

It can be known from the foregoing technical solution that, in an aspect, a shared memory space is provided for a proxy service program and a file access service program, and the shared memory space is loaded for a secure container, so that a file access service program corresponding to the secure container can directly obtain file data that needs to be accessed from the shared memory space without reserving a private data cache for each secure container, thereby reducing memory overheads and implementing high file I/O performance by using fewer memory resources in a virtualized environment.

In another aspect, since the proxy service program may copy file data in a file system to the shared memory space, and the file access service program may directly obtain the file data from the shared memory space, the file access service program directly interacts with a file system server without using a complex communication protocol, thereby reducing virtualization overheads in a file access process.

In still another aspect, in response to an access request of the target secure container for target file data, the file access service program corresponding to the target secure container may obtain the target file data from the shared memory space. Since the file access service program may access the file data by using a memory read/write instruction rather than by using a system function such as file read/write, the efficiency of accessing the file data by the secure container is improved.

Corresponding to the embodiment of the foregoing file access method, this specification further provides an embodiment of a file access system and an embodiment of a file access apparatus.

In this specification, the file access system may perform step 302 to step 306, to implement the technical solution of this specification.

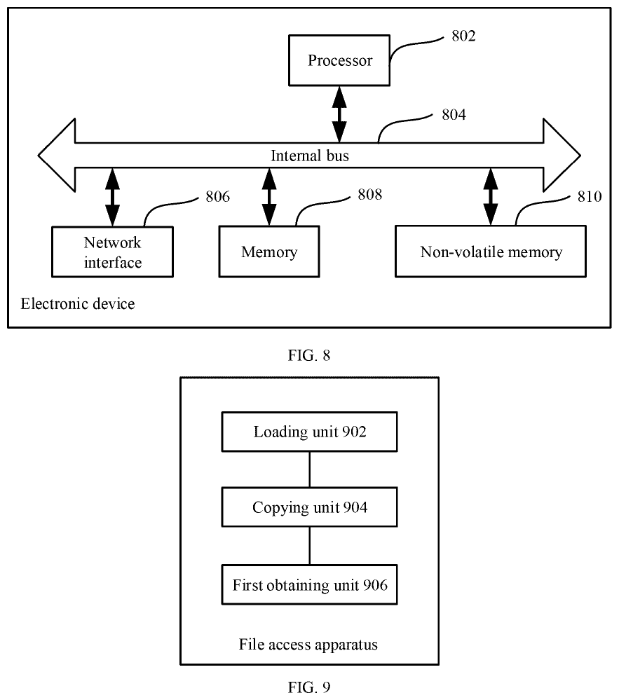

Refer to FIG. 8, FIG. 8 is a structural diagram of hardware of an electronic device in which a file access apparatus is located according to an exemplary embodiment. From a perspective of hardware, the device includes a processor 802, an internal bus 804, a network interface 806, a memory 808, and a non-volatile memory 810. Certainly, the device may further include other required hardware. One or more embodiments of this specification may be implemented based on software. For example, the processor 802 reads a corresponding computer program from a non-volatile memory 810 and runs the computer program in the memory 808. Certainly, in addition to a software implementation, one or more embodiments of this specification do not exclude other implementations, for example, logic devices or a software-hardware combination. That is, executive entities of the following processing procedures are not limited to logic units and may alternatively be hardware or logic devices.

Refer to FIG. 9, FIG. 9 is a block diagram of a file access apparatus according to an exemplary embodiment. The file access apparatus may be applied to the electronic device shown in FIG. 8, to implement the technical solution of this specification. Where the file access apparatus may be applied to a file system client corresponding to a secure container running in a guest; the file system client includes a proxy service program deployed in a host user space and a file access service program deployed in a guest kernel space; and the file access apparatus may include: a loading unit 902, configured to load a shared memory space between the proxy service program and the file access service program for a target secure container; a copying unit 904, configured to copy, by the proxy service program, file data in a file system proxied by the proxy service program to the shared memory space; and a first obtaining unit 906, configured to obtain, by the file access service program corresponding to the target secure container, target file data from the shared memory space, in response to an access request of the target secure container for the target file data.

In this embodiment, the loading unit 902 is specifically configured to: allocate a private virtual address space corresponding to the shared memory space to a file access program corresponding to the target secure container; and map a shared physical address space that is applied for by the proxy service program and that corresponds to the shared memory space to the private virtual address space allocated to the file access program corresponding to the target secure container, to complete loading of the shared memory space for the target secure container.

In this embodiment, the first obtaining unit 906 is specifically configured to: search for, by the file access service program corresponding to the target secure container, the target file data in the shared memory space, in response to the access request of the target secure container for the target file data; and read, by the file access service program corresponding to the target secure container, the target file data from the shared memory space, if the file access service program corresponding to the target secure container finds the target file data in the shared memory space.

In this embodiment, the apparatus further includes: a sending unit, configured to send, by the file access service program corresponding to the target secure container, an access request for the target file data to the proxy service program, if the file access service program corresponding to the target secure container does not find the target file data in the shared memory space; and a second obtaining unit, configured to obtain, by the proxy service program, the target file data from the file system, in response to the access request, where the copying unit 904 is further configured to copy the obtained target file data to the shared memory space; and the first obtaining unit 906 is further configured to read, by the file access service program corresponding to the target secure container, the target file data from the shared memory space.

In this embodiment, the copying unit 904 is specifically configured to: copy, by the proxy service program, the file data in the file system proxied by the proxy service program to a first memory address space in the shared memory space, where the first memory address space is used for storing file data shared by the file access service program and the proxy service program; and store, by the proxy service program, a layout index corresponding to the file data copied to the first memory address space into the shared memory space, where the layout index is used for indicating an index node of the file data corresponding to the layout index, and is used for indicating a file offset of the file data corresponding to the layout index; and the file offset is an offset of the corresponding file data in a file in which the file data is located.

In this embodiment, the access request carries a target layout index corresponding to the target file data; and the first obtaining unit 906 is specifically configured to: calculate, by the file access service program corresponding to the target secure container, a hash value of the target layout index, in response to the access request of the target secure container for the target file data, perform a modulo operation on the hash value, and determine a target memory address of the target file data in the first memory address space according to a modulo value; determine whether a layout index that corresponds to the target memory address and that is stored in the shared memory space is consistent with the target layout index; and read, by the file access service program corresponding to the target secure container, the target file data from the first memory address space according to the target memory address, if the layout index corresponding to the target memory address is consistent with the target layout index.

In this embodiment, the access request is used for performing a write operation on the target file data, and the apparatus further includes a write operation unit, configured to: copy, by the file access service program corresponding to the target secure container, the found target file data to a second memory address space in the shared memory space, where the second memory address space is a memory address space that is allocated to the target secure container in the shared memory space and that is used for performing a write log operation on the target file data; perform, by the file access service program corresponding to the target secure container, a write log operation on the target file data copied to the second memory address space, to obtain target file data modified by the target secure container; and update, by the proxy service program, the target file data stored in the first memory address space according to the target file data that is modified by the target secure container and that is stored in the second memory address space.

In this embodiment, the shared memory space further stores a use identifier and a version identifier that correspond to file data, and the write operation unit is further configured to: update a use identifier corresponding to the target file data from a first value to a second value, in response to that the write log operation is performed on the target file data, where in case of being the first value, the use identifier is used for indicating that no write log operation is being performed on the corresponding file data; and in case of being the second value, the use identifier is used for indicating that a write log operation is being performed on the corresponding file data; and update, in response to that the proxy service program completes updating the target file data stored in the first memory address space, the use identifier corresponding to the target file data from the second value to the first value, and update a version identifier corresponding to the target file data.

In this embodiment, the access request is used for performing a read operation on the target file data; and the first obtaining unit 906 is further configured to: obtain the version identifier corresponding to the target file data from the shared memory space, in response to that the file access service program corresponding to the target secure container finds the target file data in the shared memory space; re-obtain a version identifier corresponding to the target file data from the shared memory space, in response to that the file access service program corresponding to the target secure container completes reading the target file data from the shared memory space, and determine whether the re-obtained version identifier is consistent with the previously obtained version identifier; and re-read, by the file access service program corresponding to the target secure container, the target file data from the shared memory space if the re-obtained version identifier is inconsistent with the previously obtained version identifier.

In this embodiment, the file system client supports accessing a plurality of file systems; a plurality of proxy service programs that respectively proxy the plurality of file systems are deployed in the host user space; the shared memory space includes a plurality of shared memory subspaces respectively allocated to the plurality of proxy service programs; and the apparatus further includes: an allocation unit, configured to determine, according to a quantity of access times that the target secure container accesses each file system of the plurality of file systems, a cache size of a shared memory subspace allocated to each file system.

For implementation processes of functions and roles of the units in the foregoing apparatus, specifically refer to implementation processes of corresponding steps in the foregoing method. Details are not described herein again.

An apparatus embodiment substantially corresponds to a method embodiment. Therefore, for related parts, reference may be made to partial descriptions in the method embodiment. The foregoing described apparatus embodiments are merely examples. The units described as separate parts may or may not be physically separate, and the parts displayed as units may or may not be physical units, may be located in one position, or may be distributed on a plurality of network units. Some or all of the modules may be selected based on actual requirements to achieve the objectives of the solutions of this specification. A person of ordinary skill in the art may understand and implement the solutions without creative efforts.

The system, the apparatus, the module or the unit described in the foregoing embodiments may be specifically implemented by a computer chip or an entity, or implemented by a product having specific functions. A typical implementation device is a computer. A specific form of the computer may be a personal computer, a laptop computer, a cellular phone, a camera phone, a smartphone, a personal digital assistant, a media player, a navigation device, an email transceiver device, a game console, a tablet computer, a wearable device or a combination of any devices of these devices.

In a typical configuration, the computer includes one or more central processing units (CPU), an input/output interface, a network interface, and a memory.

The memory may include a form such as a volatile memory, a random access memory (RAM), and/or a non-volatile memory such as a read-only memory (ROM) or a flash memory (flash RAM) in a computer-readable medium. The memory is an example of the computer-readable medium.

The computer-readable medium includes a non-volatile medium, a volatile medium, a removable medium, and a non-removable medium, which may implement information storage by using any method or technology. The information may be computer-readable instructions, a data structure, a module of a program, or other data. Examples of a storage medium of a computer include, but are not limited to, a phase-change memory (PRAM), a static random-access memory (DRAM), another type of random-access memory (RAM), a random only memory (ROM), an electrically erasable programmable read-only memory (EEPROM), a flash memory or other memory technologies, a compact disk read-only memory (CD-ROM), a digital versatile disk (DVD) or another optical storage device, a cassette tape, a magnetic disk storage, a quantum memory, a graphene-based storage medium or another magnetic storage device, or any other non-transmission medium, which may be configured to store information accessible by a computing device. Based on the definitions herein, the computer-readable medium does not include transitory computer-readable media (transitory media), such as a modulated data signal and a carrier.

User information (including but not limited to user equipment information, user personal information, and the like) and data (including but not limited to data for analysis, stored data, displayed data, and the like) in the present disclosure are all information and data that are authorized by a user or that are fully authorized by all parties, and the collection, using and processing of related data needs to be complied with relevant laws, regulations, and standards of relevant countries and regions. In addition, a corresponding operation entry is provided for the user to select for authorization or rejection.

It should be further noted that, the terms “include”, “comprise”, or any variants thereof are intended to cover a non-exclusive inclusion. Therefore, a process, method, article, or device that includes a series of elements not only includes such elements, but also includes other elements not specified expressly, or may include inherent elements of the process, method, article, or device. Unless otherwise specified, an element limited by “including a/an . . . ” does not exclude that other same elements exist in the process, method, article, or device including the element.

Specific embodiments of this specification are described above. Other embodiments fall within a scope of the appended claims. In some embodiments, the actions or steps recorded in the claims may be performed in sequences different from those in the embodiments and an expected result may still be achieved. In addition, processes depicted in accompanying drawings are not necessarily performed in a specific sequence or successively to achieve an expected result. In some implementations, multitasking and parallel processing may also be feasible or beneficial.

Terms used in one or more embodiments of this specification are merely used to describe specific embodiments but are not intended to limit one or more embodiments of this specification. “A/an”, “the”, and “this” in a singular form used in one or more embodiments of this specification and the appended claims are also intended to include a plural form, unless other meanings are clearly indicated in the context. It should also be understood that, the term “and/or” used herein indicates and includes any or all possible combinations of one or more associated listed items.

It should be understood that although the terms “first”, “second”, “third”, and the like may be used to describe various information in one or more embodiments of this specification, such information should not be limited to these terms. The terms are only used to differentiate the same type of information. For example, without departing from the scope of one or more embodiments of this specification, first information may alternatively be referred to as second information. Similarly, second information may alternatively be referred to as first information. Depending on the context, for example, the word “if” used herein may be interpreted as “while” or “when” or “in response to determining . . . ”.

The foregoing descriptions are merely preferred embodiments of one or more embodiments of this specification, but are not intended to limit the one or more embodiments of this specification. Any modification, equivalent replacement, or improvement made within the spirit and principle of one or more embodiments of this specification shall fall within the protection scope of the one or more embodiments of this specification.

1. A file access method, wherein the method is applied to a file system client corresponding to a secure container running in a guest, the file system client comprises a proxy service program deployed in a host user space and a file access service program deployed in a guest kernel space, and the method comprises:
loading a shared memory space between the proxy service program and the file access service program for a target secure container;
copying, by the proxy service program, file data in a file system proxied by the proxy service program to the shared memory space; and
obtaining, by the file access service program corresponding to the target secure container, target file data from the shared memory space, in response to an access request of the target secure container for the target file data.

2. The method according to claim 1, wherein the loading the shared memory space between the proxy service program and the file access service program for the target secure container comprises:
allocating a private virtual address space corresponding to the shared memory space to a file access program corresponding to the target secure container; and
mapping a shared physical address space that is applied for by the proxy service program and that corresponds to the shared memory space to the private virtual address space allocated to the file access program corresponding to the target secure container, to complete loading of the shared memory space for the target secure container.

3. The method according to claim 1, wherein the obtaining, by the file access service program corresponding to the target secure container, the target file data from the shared memory space, in response to the access request of the target secure container for the target file data comprises:
searching for, by the file access service program corresponding to the target secure container, the target file data in the shared memory space, in response to the access request of the target secure container for the target file data; and
reading, by the file access service program corresponding to the target secure container, the target file data from the shared memory space, in case that the file access service program corresponding to the target secure container finds the target file data in the shared memory space.

4. The method according to claim 3, wherein the method further comprises:
sending, by the file access service program corresponding to the target secure container, an access request for the target file data to the proxy service program, in case that the file access service program corresponding to the target secure container does not find the target file data in the shared memory space;
obtaining, by the proxy service program, the target file data from the file system, in response to the access request, and copying the obtained target file data to the shared memory space; and
reading, by the file access service program corresponding to the target secure container, the target file data from the shared memory space.

5. The method according to claim 1, wherein the copying, by the proxy service program, the file data in the file system proxied by the proxy service program to the shared memory space comprises:
copying, by the proxy service program, the file data in the file system proxied by the proxy service program to a first memory address space in the shared memory space, wherein the first memory address space is used for storing file data shared by the file access service program and the proxy service program; and
storing, by the proxy service program, a layout index corresponding to the file data copied to the first memory address space into the shared memory space, wherein the layout index is used for indicating an index node of the file data corresponding to the layout index, and is used for indicating a file offset of the file data corresponding to the layout index; and the file offset is an offset of the file data in a file in which the file data is located.

6. The method according to claim 5, wherein the access request carries a target layout index corresponding to the target file data; and
the obtaining, by the file access service program corresponding to the target secure container, the target file data from the shared memory space, in response to the access request of the target secure container for the target file data comprises:
calculating, by the file access service program corresponding to the target secure container, a hash value of the target layout index, in response to the access request of the target secure container for the target file data, performing a modulo operation on the hash value, and determining a target memory address of the target file data in the first memory address space according to a modulo value;
determining whether a layout index that corresponds to the target memory address and that is stored in the shared memory space is consistent with the target layout index; and
reading, by the file access service program corresponding to the target secure container, the target file data from the first memory address space according to the target memory address, in case that the layout index corresponding to the target memory address is consistent with the target layout index.

7. The method according to claim 5, wherein the access request is used for performing a write operation on the target file data, and the method further comprises:
copying, by the file access service program corresponding to the target secure container, the found target file data to a second memory address space in the shared memory space, wherein the second memory address space is a memory address space that is allocated to the target secure container in the shared memory space and that is used for performing a write log operation on the target file data;
performing, by the file access service program corresponding to the target secure container, a write log operation on the target file data copied to the second memory address space, to obtain target file data modified by the target secure container; and
updating, by the proxy service program, the target file data stored in the first memory address space according to the target file data that is modified by the target secure container and that is stored in the second memory address space.

8. The method according to claim 7, wherein the shared memory space further stores a use identifier and a version identifier that correspond to file data, and the method further comprises:
updating a use identifier corresponding to the target file data from a first value to a second value, in response to that the write log operation is performed on the target file data, wherein in case of being the first value, the use identifier is used for indicating that no write log operation is being performed on the file data; and in case of being the second value, the use identifier is used for indicating that a write log operation is being performed on the file data; and
updating, in response to that the proxy service program completes updating the target file data stored in the first memory address space, the use identifier corresponding to the target file data from the second value to the first value, and updating a version identifier corresponding to the target file data.

9. The method according to claim 8, wherein the access request is used for performing a read operation on the target file data, and the method further comprises:
obtaining the version identifier corresponding to the target file data from the shared memory space, in response to that the file access service program corresponding to the target secure container finds the target file data in the shared memory space;
re-obtaining a version identifier corresponding to the target file data from the shared memory space, in response to that the file access service program corresponding to the target secure container completes reading the target file data from the shared memory space, and determining whether the re-obtained version identifier is consistent with the previously obtained version identifier; and re-reading, by the file access service program corresponding to the target secure container, the target file data from the shared memory space in case that the re-obtained version identifier is inconsistent with the previously obtained version identifier.

10. The method according to claim 1, wherein the file system client supports accessing a plurality of file systems, a plurality of proxy service programs that respectively proxy the plurality of file systems are deployed in the host user space, the shared memory space comprises a plurality of shared memory subspaces respectively allocated to the plurality of proxy service programs, and the method further comprises:
determining, according to a quantity of access times that the target secure container accesses each file system of the plurality of file systems, a cache size of a shared memory subspace allocated to each file system.

11. A file access system, wherein the file access system comprises a file system client corresponding to a secure container running in a guest, and the file system client comprises a proxy service program deployed in a host user space and a file access service program deployed in a guest kernel space; and
the file system client is configured to implement;
loading a shared memory space between the proxy service program and the file access service program for a target secure container;
copying, by the proxy service program, file data in a file system proxied by the proxy service program to the shared memory space; and
obtaining, by the file access service program corresponding to the target secure container, target file data from the shared memory space, in response to an access request of the target secure container for the target file data.

12. An electronic device, comprising a communication interface, a processor, a memory, and a bus, wherein the communication interface, the processor, and the memory are connected to each other through the bus; and
the memory stores a machine-readable instruction which, when called by the processor, enables the processor to:
load a shared memory space between a proxy service program deployed in a host user space and a file access service program deployed in a guest kernel space for a target secure container;
copy, by the proxy service program, file data in a file system proxied by the proxy service program to the shared memory space; and
obtain, by the file access service program corresponding to the target secure container, target file data from the shared memory space, in response to an access request of the target secure container for the target file data.

13. A non-volatile machine-readable storage medium, wherein the machine-readable storage medium stores a machine-readable instruction, and the machine-readable instruction, when called and executed by a processor, implements the method according to claim 1.

14. The system according to claim 11, wherein when loading the shared memory space between the proxy service program and the file access service program for the target secure container, the file system client is specifically configured to implement:
allocating a private virtual address space corresponding to the shared memory space to a file access program corresponding to the target secure container; and
mapping a shared physical address space that is applied for by the proxy service program and that corresponds to the shared memory space to the private virtual address space allocated to the file access program corresponding to the target secure container, to complete loading of the shared memory space for the target secure container.

15. The system according to claim 11, wherein when obtaining, by the file access service program corresponding to the target secure container, the target file data from the shared memory space, in response to the access request of the target secure container for the target file data, the file system client is specifically configured to implement:
searching for, by the file access service program corresponding to the target secure container, the target file data in the shared memory space, in response to the access request of the target secure container for the target file data; and
reading, by the file access service program corresponding to the target secure container, the target file data from the shared memory space, in case that the file access service program corresponding to the target secure container finds the target file data in the shared memory space.

16. The system according to claim 15, wherein the file system client is further configured to implement:
sending, by the file access service program corresponding to the target secure container, an access request for the target file data to the proxy service program, in case that the file access service program corresponding to the target secure container does not find the target file data in the shared memory space;
obtaining, by the proxy service program, the target file data from the file system, in response to the access request, and copying the obtained target file data to the shared memory space; and
reading, by the file access service program corresponding to the target secure container, the target file data from the shared memory space.

17. The system according to claim 11, wherein when copying, by the proxy service program, the file data in the file system proxied by the proxy service program to the shared memory space, the file system client is specifically configured to implement:
copying, by the proxy service program, the file data in the file system proxied by the proxy service program to a first memory address space in the shared memory space, wherein the first memory address space is used for storing file data shared by the file access service program and the proxy service program; and
storing, by the proxy service program, a layout index corresponding to the file data copied to the first memory address space into the shared memory space, wherein the layout index is used for indicating an index node of the file data corresponding to the layout index, and is used for indicating a file offset of the file data corresponding to the layout index; and the file offset is an offset of the file data in a file in which the file data is located.

18. The system according to claim 17, wherein the access request carries a target layout index corresponding to the target file data; and
when obtaining, by the file access service program corresponding to the target secure container, the target file data from the shared memory space, in response to the access request of the target secure container for the target file data, the file system client is specifically configured to implement:
calculating, by the file access service program corresponding to the target secure container, a hash value of the target layout index, in response to the access request of the target secure container for the target file data, performing a modulo operation on the hash value, and determining a target memory address of the target file data in the first memory address space according to a modulo value;
determining whether a layout index that corresponds to the target memory address and that is stored in the shared memory space is consistent with the target layout index; and
reading, by the file access service program corresponding to the target secure container, the target file data from the first memory address space according to the target memory address, in case that the layout index corresponding to the target memory address is consistent with the target layout index.

19. The system according to claim 17, wherein the access request is used for performing a write operation on the target file data, and the file system client is further configured to implement:
copying, by the file access service program corresponding to the target secure container, the found target file data to a second memory address space in the shared memory space, wherein the second memory address space is a memory address space that is allocated to the target secure container in the shared memory space and that is used for performing a write log operation on the target file data;
performing, by the file access service program corresponding to the target secure container, a write log operation on the target file data copied to the second memory address space, to obtain target file data modified by the target secure container; and
updating, by the proxy service program, the target file data stored in the first memory address space according to the target file data that is modified by the target secure container and that is stored in the second memory address space.

20. The system according to claim 19, wherein the shared memory space further stores a use identifier and a version identifier that correspond to file data, and the file system client is further configured to implement:
updating a use identifier corresponding to the target file data from a first value to a second value, in response to that the write log operation is performed on the target file data, wherein in case of being the first value, the use identifier is used for indicating that no write log operation is being performed on the file data; and in case of being the second value, the use identifier is used for indicating that a write log operation is being performed on the file data; and
updating, in response to that the proxy service program completes updating the target file data stored in the first memory address space, the use identifier corresponding to the target file data from the second value to the first value, and updating a version identifier corresponding to the target file data.
